(19) United States
(12) Patent Application Publication
(10) Pub. No.: US 2020/0025723 A1
(43) Pub. Date: Jan. 23, 2020

(54) DISPERSIVE ELEMENT IN LIQUID CHROMATOGRAPHY SYSTEMS

(71) Applicant: Waters Technologies Corporation, Milford, MA (US)

(72) Inventors: Martin Gilar, Franklin, MA (US); Fabrice Gritti, Franklin, MA (US); Thomas S. McDonald, Littleton, MA (US)

(21) Appl. No.: 16/518,388

(22) Filed: Jul. 22, 2019

Related U.S. Application Data
(60) Provisional application No. 62/701,896, filed on Jul. 23, 2018.

(51) Int. Cl. G01N 30/20; G01N 30/22; B01J 20/281; G01N 30/60; G01N 30/34

(52) U.S. Cl. CPC G01N 30/20; G01N 30/22; G01N 2030/347; G01N 30/603; G01N 30/34; G01N 30/48

(57) ABSTRACT

A liquid chromatography system including a solvent delivery pump for delivering a mobile phase through the liquid chromatography system, an injector for injecting a sample into the mobile phase, a column for effecting a separation of components of the sample, and a dispersive element positioned between the injector and the column, the dispersive element configured to dilute a sample solvent in the mobile phase prior to entering the column is provided. Further dispersive elements, systems, and methods are also provided.

### RELATED APPLICATIONS

This application is a non-provisional patent application claiming priority to U.S. Provisional Patent Application No. 62/701,896, filed Jul. 23, 2018, entitled “Dispersive Element in Liquid Chromatography Systems,” which is incorporated herein by reference.

### FIELD OF TECHNOLOGY

The following relates to a dispersive element in a liquid chromatography system, and more specifically to a liquid chromatography system having a dispersive element for enabling an injection of a sample dissolved in a strong solvent.

### BACKGROUND

Liquid chromatography is a technique in analytic chemistry where distinct components of a mixture are identified by separating the individual components by passing the mixture through a stationary phase using fluid flow so that the components elute at different rates. Liquid chromatography systems are typically comprised of a solvent delivery pump, an autosampler, an injector, a column, and a detector. The solvent delivery pump pumps mobile phase fluid through the system, the autosampler and injector introduce the sample to be analyzed to the analytic flow path, the column contains the packing material used to effect separation, and the detector detects the separated components as they elute out of the column.

Certain samples for liquid chromatographic analysis must be dissolved in strong sample solvents for injecting into the column. A strong sample solvent acts as a mobile phase during a beginning of the chromatographic separation, which can lead to either peak broadening or complete sample breakthrough. Currently, there are techniques for sample dilution at the column used in preparative scale chromatography to counteract peak broadening or complete sample breakthrough using a diluent to dilute the sample solvent down to an acceptable level. However, the active addition of diluent or a segmented injection into a stream of weak mobile phase requires an additional pump, a pump control, a rationally timed multiple injection, user intervention etc.

### SUMMARY

A first general aspect relates to a dispersive element in a liquid chromatography system, the liquid chromatography system including a solvent pump, an injector, a column, and a detector, the dispersive element comprising: a pre-column body including dispersing materials, positioned between the injector and the column, wherein the dispersing materials dilute a mobile phase comprising a strong sample solvent prior to entering the column.

In an exemplary embodiment, a concentration of the strong sample solvent is reduced 10-fold or more by the dispersive element.

In an exemplary embodiment, the dispersing materials are a packed bed of chemically inert, non-retentive sorbent materials. The chemically inert, non-retentive sorbent materials have a particle size between 25 μm and 100 μm.

In an exemplary embodiment, the pre-column body is fluidically connected to the injector at an inlet end to receive the mobile phase from the injector. The pre-column body is fluidically connected to the column at an outlet end opposing the inlet end, to deliver the diluted mobile phase to the column.

In an exemplary embodiment, the pre-column body is directly connected to the column at the outlet end of the pre-column body.

In an exemplary embodiment, the high-pressure compatible cartridge is connected to the column via a length of tubing between the outlet end of the pre-column body and the column.

In an exemplary embodiment, a length and a volume of the pre-column body is less than a length of the column. The length of the pre-column body is between 100 mm and 30 mm.

A second general aspect relates to a liquid chromatography system comprising: a solvent delivery pump for delivering a mobile phase through the liquid chromatography system, an injector for injecting a sample into the mobile phase, a column for effecting a separation of components of the sample, and a dispersive element positioned between the injector and the column, the dispersive element configured to dilute a sample solvent in the mobile phase prior to entering the column.

In an exemplary embodiment, the dispersive element is a length of open tubing having a curvilinear or rectangular cross-section.

In an exemplary embodiment, the dispersive element is a pre-column body having a packed bed of chemically inert, non-retentive sorbent material disposed therein.

In an exemplary embodiment, the dispersive element is a microfluidic mixer.

In an exemplary embodiment, the dispersive element is a frit comprised of chemically inert material.

In an exemplary embodiment, the dispersive element is fluidically connected to the injector at an inlet end to receive the mobile phase from the injector.

In an exemplary embodiment, the dispersive element is connected to the column via a length of tubing between the outlet end of the dispersive element and the column.

In an exemplary embodiment, the dispersive element is one or more dispersive elements in series, prior to the column, the one or more dispersive elements in series configured to progressively dilute the sample solvent in the mobile phase.

A third general aspect relates to a liquid chromatography system for controlled dispersion of a mobile phase, the liquid chromatography system comprising: a solvent delivery pump for delivering the mobile phase through the liquid chromatography system, an injector for injecting a sample into the mobile phase, a first flow path fluidically connecting the injector to a dispersive element, wherein a sample solvent is diluted by the dispersive element prior to the mobile phase entering the column, and a second flow path fluidically connecting the injector to the column to bypass the dispersive element.

In an exemplary embodiment, one or more flow control devices control a flow of the mobile phase through the first flow path or the second flow path. The one or more flow control devices is selected from the group consisting of: a jumper, a tool-less connector, a solvent stream selector valve, and a switching valve.

A fourth general aspect relates to a method for enabling an injection of a sample dissolved in a strong solvent, in a liquid chromatography system, the method comprising: disposing a dispersive element between an injector and a column, and diluting a sample solvent of a mobile phase, by the dispersive element, prior to the mobile phase entering the column, and wherein, as a function of the diluting, a concentration of the sample solvent in the mobile phase is reduced to mitigate an effect of the strong solvent.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a schematic diagram of an embodiments of a liquid chromatography system;

FIG. 2 depicts a schematic diagram of an embodiment of a dispersive element directly attached to the column;

FIG. 3 depicts a schematic diagram of an embodiment of a dispersive element attached to the column via tubing;

FIG. 4 depicts a schematic diagram of multiple dispersive elements attached to a column;

FIG. 5 depicts a schematic diagram of multiple dispersive elements attached to a column via tubing;

FIG. 6A depicts a schematic diagram of a first embodiment of a liquid chromatography system for controlled dispersion;

FIG. 6B depicts a schematic diagram of a second embodiment of a liquid chromatography system for controlled dispersion;

FIG. 7A depicts an existing liquid chromatography system;

FIG. 7B depicts an alternative embodiment of a liquid chromatography system;

FIG. 8 depicts a first graph showing a dilution of sample solvent with the use of a dispersive element;

FIG. 9 depicts a second graph showing a dilution of sample solvent with the use of a dispersive element;

FIG. 10 depicts a third graph showing a dilution of sample solvent with the use of a dispersive element;

FIG. 11 depicts a first chromatogram without a use of a dispersive element;

FIG. 12 depicts a second chromatogram without a use of a dispersive element;

FIG. 13 depicts a first chromatogram with the use of a dispersive element;

FIG. 14 depicts a second chromatogram with the use of a dispersive element;

FIG. 15 depicts a third chromatogram without the use of a dispersive element;

FIG. 16 depicts a fourth chromatogram without the use of a dispersive element; and

FIG. 17 depicts a third chromatogram with the use of a dispersive element.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

A liquid chromatography system includes a dispersive element, either as part of the injector or as an additional component immediately downstream of the injector. The dispersive element broadens an injected slug of sample into a weak solvent (e.g. initial mobile phase). If the dispersion lent by the dispersive element is substantial, a concentration of sample solvent is reduced (e.g. by 10-fold or more) without the need for an additional pump, such as a diluent pump. In one implementation, the dispersive element is a mixer having of one or multiple of the following components: an open tube, a packed mixer, a frit, an active mixer, or other dispersion element prior to the column. In another implementation, the dispersive element is used in the place of sample loop, post loop or just prior to the column.

A role of the dispersive element is to disperse an injected sample “plug” into the running mobile phase, which dilutes the sample solvent strength by a weak mobile phase. Dispersing the injected sample mixture mitigates negative effects of using a strong sample solvent to dissolve a sample, and focuses the sample plug at the head of the column. Any added system dispersion is generally undesirable in liquid chromatography, such as high-performance liquid chromatography (HPLC) and ultra-high performance liquid chromatography (UHPLC). As a result, the dispersive element provides a controlled dispersion. Controlled dispersion is achieved by placing a dispersive element or a series of dispersive elements in a flow path of the liquid chromatography system equipped with a series of flow control devices, such as switching valves or fluidic jumpers that either include or bypass the dispersive element(s). The controlled dispersion allows users to have access to both a low-dispersion or no-dispersion system and a system with sufficient dispersion to handle specific sample loading requirements. A configuration change between these systems could be accomplished via software or simple re-plumbing, as described in greater detail below.

The introduction of a dispersive element in the liquid chromatography flow path is desirable for special situations, such as the injection of sample in a strong solvent. A strong solvent is a solvent having a high concentration of organic solvent(s). A common problem in liquid chromatography is the necessity to dissolve a sample in a suitable solvent ensuring the solubility and long-term stability of the sample. For example, in glycan analysis, the sample is well-soluble in aqueous solvent, which is too strong to be injected on a hydrophilic interaction chromatography (HILIC) column. If the sample is prepared in 90% acetonitrile (e.g. an initial mobile phase strength in HILIC), the high molecular weight glycans precipitate from the solution. As a compromise, users typically prepare glycan samples in 70% acetonitrile and inject 3-4 μL of sample to the UPLC system having a 2.1 mm inner diameter column, but peak splitting is visible when larger volumes are introduced. The desired dilution (e.g. at least 2-4 fold dilution) of the organic strength of the strong solvent accomplished by the dispersive element described herein mitigates this problem and permits larger volume injection, or injection of the same sample volume dissolved in more aqueous solvent (e.g. water is the strong solvent in HILIC). Similar scenarios can be found in peptide mapping in reversed phase liquid chromatography. Hydrophobic peptides are insoluble in fully aqueous solvents, while hydrophilic peptides are distorted when using 10-30% acetonitrile as a sample solvent. Solvent strength dilution via incorporation of a dispersive element(s) resolves this issue. A third scenario is in preparative liquid chromatography, where the samples are often dissolved in dimethyl sulfoxide (DMSO) or pure methanol. With a dispersive element inline, a user can load substantial volumes onto the main column directly without the need for an additional diluent pump at to achieve at-column dilution.

However, if the sample is dissolved in a weak solvent compatible with the liquid chromatography separation, the dispersion element may be unnecessary, and potentially harmful to the chromatographic process, especially for isocratic separations or size exclusion chromatography. In one embodiment, a liquid chromatography system has multiple alternative flow paths built in to the system. For instance, a first flow path operates with no dispersion or minimal dispersion, while a second, different flow path(s)incorporates one or more dispersive elements to create progressively increasing dispersion. In one implementation, the dispersive element(s) is flexibly included or excluded from the flow path using fluidic connectors or flow control devices (e.g. jumpers, tool less connectors, solvent stream selector valves, and the like). An amount of desirable dispersion can be flexibly changed by the operator without re-plumbing the liquid chromatography system.

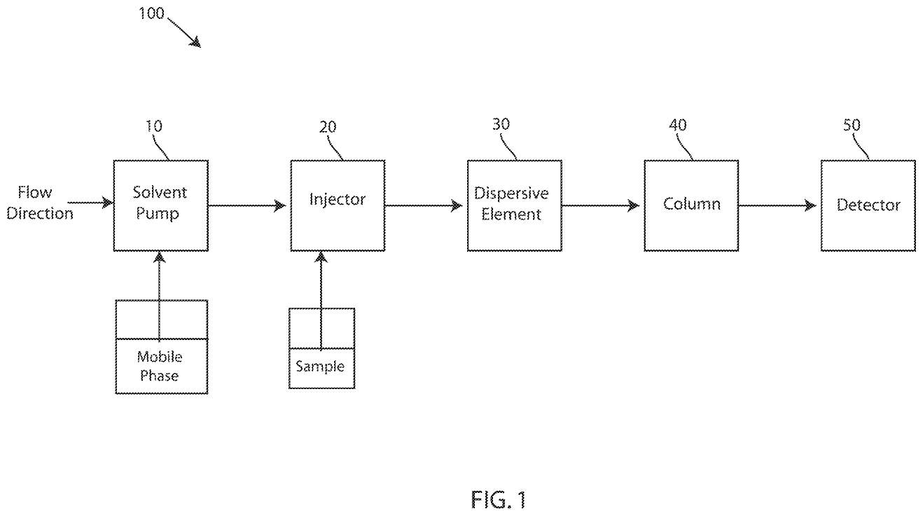

Referring to the drawings, FIG. 1 depicts a schematic diagram of an embodiment of a liquid chromatography system 100. The liquid chromatography system 100 includes a solvent pump 10, an injector 20, a column 40, and a detector 50. The solvent pump 10 is configured to deliver (e.g. pump) a mobile phase through the liquid chromatography system 100, as known to those skilled in the art of liquid chromatography. The mobile phase includes a concentration of a strong solvent necessary to dissolve a specific sample. The solvent(s) is contained in a solvent reservoir fluidically connected to the solvent pump 10. The injector 20 injects a sample into the mobile phase. The injector is a part or component of the autosampler/sample manager for effectively injecting a sample into the analytic flow path containing the mobile phase, as known to those skilled in the art or liquid chromatography. The column effect a separation of components of the sample, as known to those skilled in the art of liquid chromatography.

The liquid chromatography system 100 also includes a dispersive element 30. The dispersive element 30 is configured to disperse an injected sample “plug” into the running mobile phase, which results in diluting the sample solvent strength by a weak mobile phase. For instance, the dispersive element 30 is configured to dilute a sample solvent and reduce a concentration of a sample solvent of the mobile phase prior to entering the column. The dispersive element 30 mixes the sample with the mobile phase to dilute the sample solvent. Without diluting the sample solvent of the mobile phase, a max concentration of the solvent would immediately be achieved in the column, which can lead to peak splitting, peak broadening, etc. Furthermore, the dispersive element 30 is located prior to the column. In one implementation, the dispersive element 30 is located between the injector 20 and the column 40. In another implementation, the dispersive element 30 is a part of the injector 20. The dispersive element 30 is positioned to provide “at-column” dispersion of the sample solvent to reduce a concentration of the sample solvent prior to the mobile phase entering the column 40. In other words, the dispersive element 30 is positioned between the injector 20 and the column 40, the dispersive element configured to dilute an incompatible sample solvent in the mobile phase prior to entering the column.

Furthermore, the dispersive element 30 has various configurations, shapes, structures, and the like, which all can perform the dispersion described herein. For instance, one embodiment of the dispersive element 30 is a pre-column dispersive element having the ability to disperse a mobile phase flowing through the pre-column dispersive element to dilute the sample solvent. Dispersion is caused by passively or actively mixing the sample solvent. The dispersive element 30 achieves a passive mixing of the sample solvent prior to entering the column. The dispersive element 30 includes a first end, such as an inlet end, that is fluidically connected to the injector 20 and a second end, such as an outlet end, that is fluidically connected to the column 40. Further, the dispersive element 30 is an elongated element wherein a length and a volume of the dispersive element 30 is less than a length and a volume of the chromatographic column 40. In one implementation, the dispersive element 30 has a length between 30 mm and 100 mm. In other implementations, the length of the of dispersive element exceeds 100 mm or is smaller than 30 mm. The dispersive element 30 includes a fluidic pathway within the dispersive element 30, such that the mobile phase flows through, at high pressure, through dispersing materials, such as a packed bed of sorbent material, or through other mixing elements. The fluidic pathway extends axially through the dispersive element 30 from the inlet end to the opposing outlet end so that mobile phase passes through the dispersive element 30 and into the column 40.

In a first embodiment, the dispersive element 30 is a pre-column body having an outlet and an inlet end, and including dispersing materials disposed therein, wherein the dispersing materials dilute a mobile phase comprising a strong sample solvent prior to entering the column. In one implementation, the pre-column body is a high-pressure cartridge or tubing, which is pressure rated to handle the high pressures associated with liquid chromatography. In another implementation, the pre-column body is a chromatographic column having a packed bed of non-retentive or substantially non-retentive, chemically insert sorbent particles disposed within the chromatographic column. The pre-column body has a length and a volume less than the column 40, such as a length between 30 mm and 100 mm; shorter and longer lengths may be used as appropriate if the proper dispersion can be performed. The dispensing materials are mixing materials configured to mix the sample solvent, or other particles, materials, and the like that are suitable for passively mixing the sample solvent. The dispersing or mixing materials disposed within the pre-column body are non-retentive, chemically inert sorbent particles. For instance, the dispersive element 30 includes a packed bed of non-retentive or substantially non-retentive, chemically insert sorbent particles. Substantially non-retentive sorbent materials can be one-tenth as retentive as the column, as an example. The non-retentive or substantially non-retentive, chemically inert dispersing materials of the dispersive element 30 prevents sample from adhering to the sorbent particles within the dispersive element 30, while still performing a dispersion of the mobile phase. In one implementation, the sorbent particles of the dispersive element have a large sorbent particle size, such as a particle size between 25 μm and 100 μm. In another implementation, the sorbent particle sizes exceed 100 μm. The packed bed includes a combination of different sized particles or uniformly sized particles. In a second embodiment, the dispersive element 30 is a microfluidic mixer. The microfluidic mixer generates dispersion through mixing the sample solvent. The microfluidic mixer has various structural configurations, such as a helical mixer, a herring bone mixer, a static mixer, and the like. In a third embodiment, the dispersive element 30 is a frit comprised of inert material. In a fourth embodiment, the dispersive element 30 is a length of tubing not packed with sorbent material, having a circular or rectangular profile. The cross-section and/or the diameter of the tubing is different than a tubing of the injector 20. In a fifth embodiment, the dispersive element 30 is a smaller (e.g. lengthwise) chromatographic column packed with a large particle size retentive sorbent, although a risk of sample losses and/or carryover (i.e. non-specific adsorption) can increase.

Further, the dispersing materials of the dispersive element 30 can be different sorbents for different chromatographic applications. The sorbent particles used in one embodiment of the dispersive element 30 is a mechanically strong bare silica. The sorbent particles used in another embodiment is a diol BEH hydrophilic sorbent, which could be suitable as a dispersive column element for reversed-phase LC. However, a mechanically strong bare silica or a diol BEH hydrophilic sorbent material can become retentive in hydrophilic interaction chromatography (HILIC) mode. Other sorbents used in the dispersive element 30 include C1 methyl.

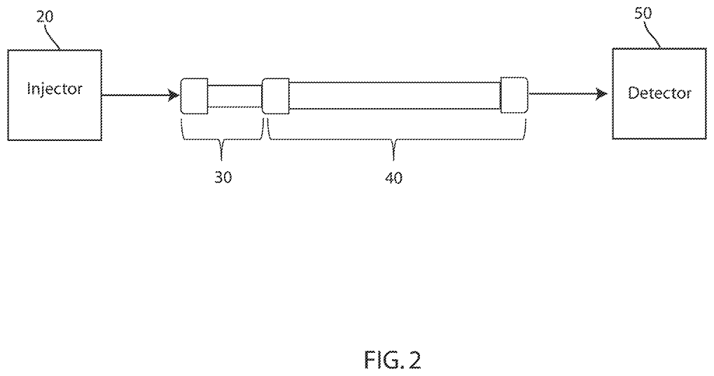

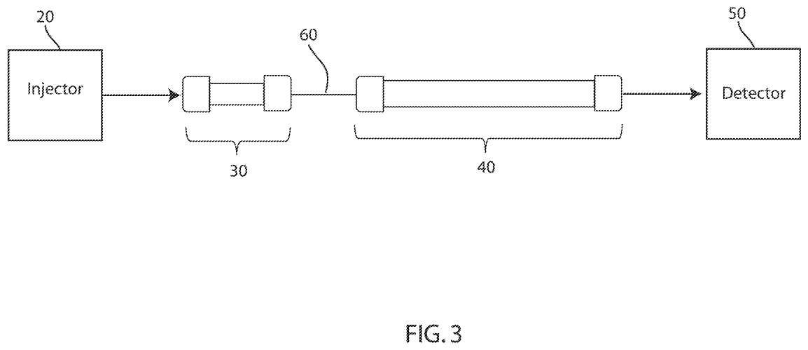

Referring now to FIG. 2, which depicts a schematic diagram of an embodiment of a dispersive element 30 directly attached to the column 40. As shown in FIG. 2, the dispersive element 30 is directly attached to an end or inlet end of the column 40. The direct connection between the dispersive element 30 and the column end 40 is accomplished by traditional high-pressure fluidic connections. The undiluted mobile phase enters the first end (e.g. inlet end) of the dispersive element 30 so that the sample solvent is diluted before entering the column 40. FIG. 3 depicts a schematic diagram of an embodiment of the dispersive element 30 attached to the column 40 via tubing 60. As shown in FIG. 3, the dispersive element 30 is indirectly attached to an end or inlet end of the column 40 via a section of tubing 60. Tubing 60 is a fluidic connection tubing that indirectly fluidically connects the dispersive element 30 with the column 40. The undiluted mobile phase enters the first end (e.g. inlet end) of the dispersive element 30 so that the sample solvent is diluted before entering the column 40, and the tubing 60 guides the diluted mobile phase to the column 40. In an embodiment where the dispersive element 30 is a part of the injector 20, the tubing 60 is useful in fluidically connecting the injector 20, the dispersive element 30, and the column 40. Further, in the embodiment shown in FIG. 3, the dispersive element 30 is remote or otherwise not directly connected to the column 40, wherein a length of tubing 60 fluidically connects the dispersive element 30 and the column 40.

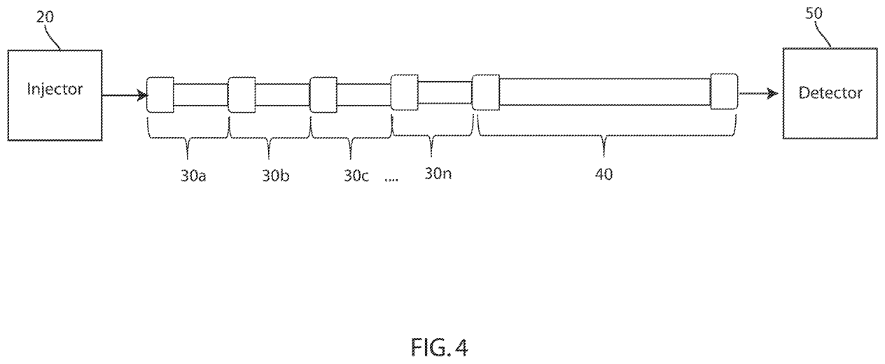

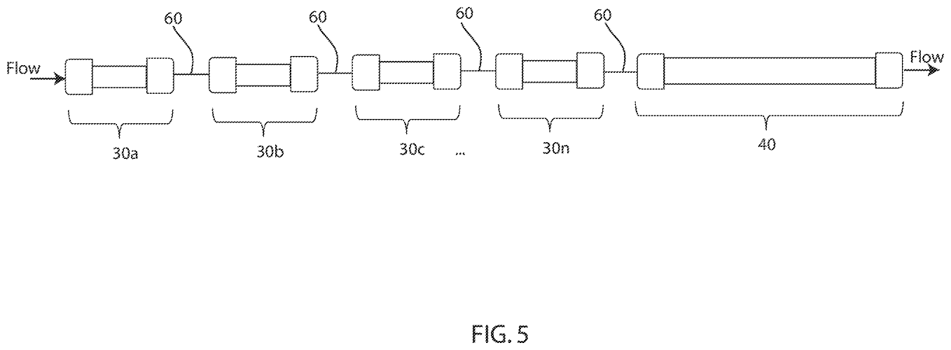

With reference now to FIG. 4, which depicts a schematic diagram of multiple dispersive elements attached to a column. The liquid chromatography system shown in FIG. 4 includes a plurality of dispersive elements 30a, 30b, 30c . . . 30n. For instance, the dispersive element 30 is comprised of one or more dispersive elements 30a, 30b, 30c . . . 30n in series, prior to the column 40, configured to progressively dilute the sample solvent in the mobile phase. The plurality of dispersive elements 30a, 30b, 30c . . . 30n are each the same type of dispersive element (e.g. four cartridges with packed bed of non-retentive sorbent material), or are a combination of different types of dispersive elements (e.g. one cartridge and one microfluidic mixer). The combination of different types of dispersive elements 30a, 30b, 30c . . . 30n can alternate or can be a selection of dispersive elements that most suitably dilute the mobile phase as desired. Moreover, the particle size of the non-retentive sorbent material within the dispersive elements 30a, 30b, 30c . . . 30n are the same for each of the plurality of dispersive elements 30a, 30b, 30c . . . 30n. Alternatively, the particle size is different for each of the plurality of dispersive elements 30a, 30b, 30c . . . 30n. In one implementation, a packed bed of sorbent material within a first dispersive element 30a of the series of dispersive elements 30a, 30b, 30c . . . 30n has a first particle size, a packed bed of sorbent material within a second dispersive element 30b of the series of dispersive elements 30a, 30b, 30c . . . 30n has a second particle size that is smaller than the first particle size, a packed bed of sorbent material within a third dispersive element 30c of the series of dispersive elements 30a, 30b, 30c . . . 30n has a third particle size that is smaller than the first and second particle size, and a packed bed of sorbent material within a nth dispersive element 30n of the series of dispersive elements 30a, 30b, 30c . . . 30n has a nth particle size, which is smaller than the first, second, and third particle size. As a result, the plurality of dispersive elements 30a, 30b, 30c, 30n are positioned in series to gradually reduce the amount of dilution that takes place within each dispersive element 30a, 30b, 30c, 30n. The plurality of dispersive elements 30a, 30b, 30c, 30n may also have particle sizes that progressively get larger to gradually increase an amount of dilution that takes place within each dispersive element 30a, 30b, 30c, 30n. In FIG. 4, each of the plurality of dispersive elements 30a, 30b, 30c, 30n are directly attached to each other, wherein the dispersive element closest to the column 40 is directly attached to the column end. FIG. 5 depicts a schematic diagram of multiple dispersive elements indirectly attached to a column. As noted above, tubing 60 fluidically connects the dispersive elements 30a, 30b, 30c, 30n to the column 40. Each of the dispersive elements 30a, 30b, 30c, 30n shown in FIG. 5 are attached to one another via tubing 60 of various length. In another embodiment (not shown), the dispersive elements 30a, 30b, 30c, 30n are directly connected to one another in series, but remote from the column 40, fluidically connected to the column 40 via tubing 60.

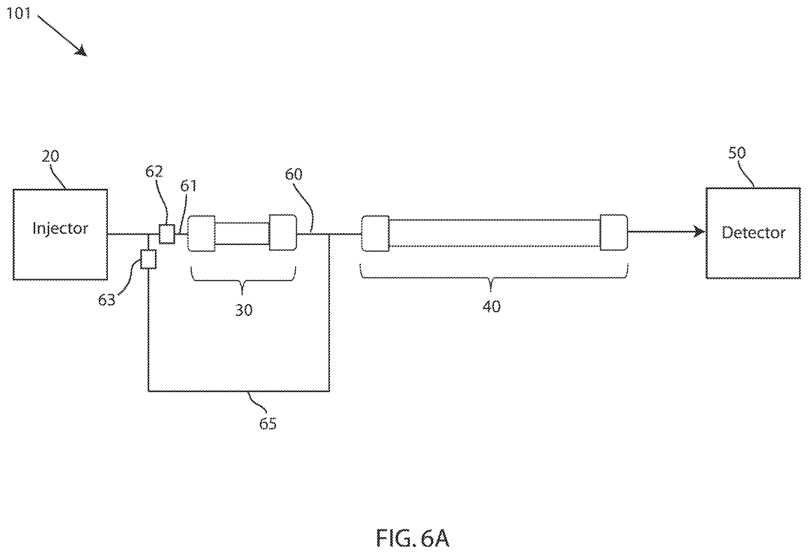

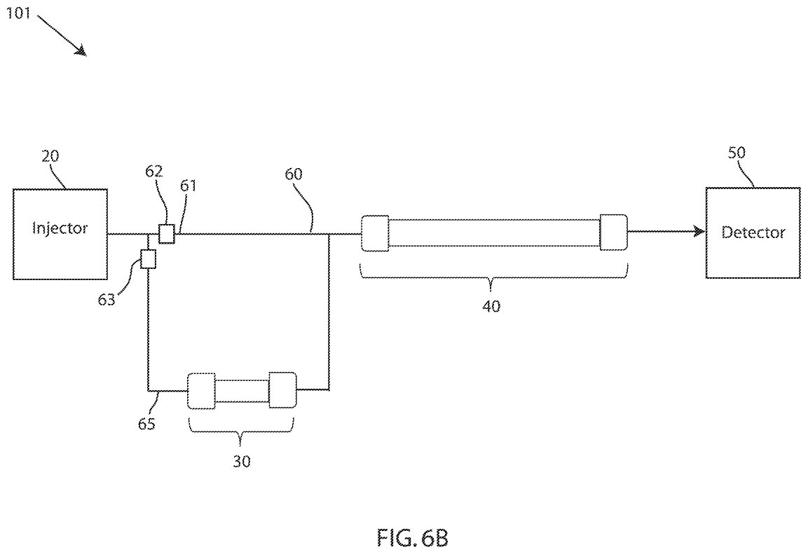

Referring now to FIG. 6A, which depicts a schematic diagram of a first liquid chromatography system 101 for controlled dispersion. The liquid chromatography system 101 for controlled dispersion of a mobile phase includes a solvent delivery pump 10 for delivering the mobile phase through the liquid chromatography system, an injector 20 for injecting a sample into the mobile phase, a first flow path 61 fluidically connecting the injector 20 to a dispersive element 30 (or more than one dispersive element 30), wherein a sample solvent is diluted by the dispersive element 30 prior to the mobile phase entering the column and a second flow path 65 fluidically connecting the injector 20 to the column 40 to bypass the dispersive element. The flow of the mobile phase is directed to pass through the first flow path 61 or through the second flow path 65, depending on whether the mobile phase should be diluted prior to the column 40. For instance, one or more flow control devices 62, 63 are actuated to control a flow of the mobile phase through the first flow path 61 or the second flow path 65. The one or more flow control devices 62, 63 may be a jumper, a tool-less connector, a solvent stream selector valve, a switching valve, and the like. The second flow path 65 can be referred to as a bypass line, bypass option, bypass flow path, and the like, because actuation and/or activation of the flow control devices 62, 63 allows an operator of a liquid chromatography system 101 to bypass the dispersive element 30 if the solvent/mobile phase is not incompatible. For example, if the flow control devices 62, 63 are valves, the valve 62 would be closed and the valve 63 would be open to take advantage of the bypass option. If the solvent is incompatible, and the operator would like to dilute the solvent, the valve 62 is open, and the valve 63 is closed. FIG. 6B depicts a schematic diagram of a second liquid chromatography system 101 for controlled dispersion. Here, the dispersive element 30 is positioned along the second flow path 65, on the bypass line.

Accordingly, the liquid chromatography system 101 provides controlled dispersion with the ability to incorporate one or more dispersive elements to create progressively increasing dispersion in one fluid path, while providing another flow path with no added dispersion after the injector 20. Thus, a single liquid chromatography machine can be used for different applications (e.g. no dispersion needed and dispersion required).

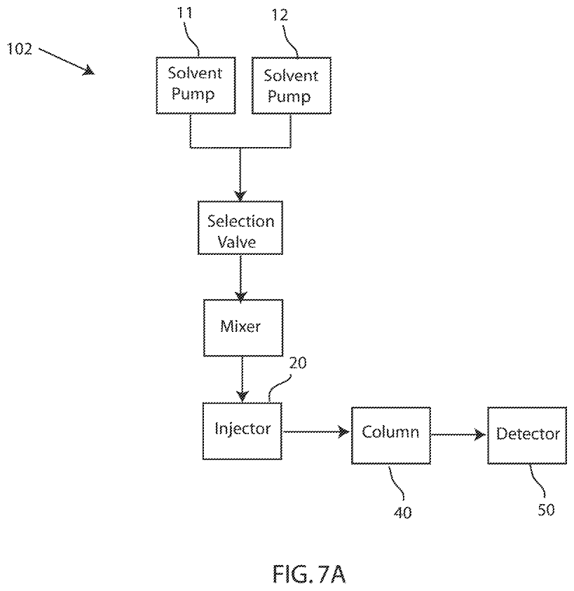

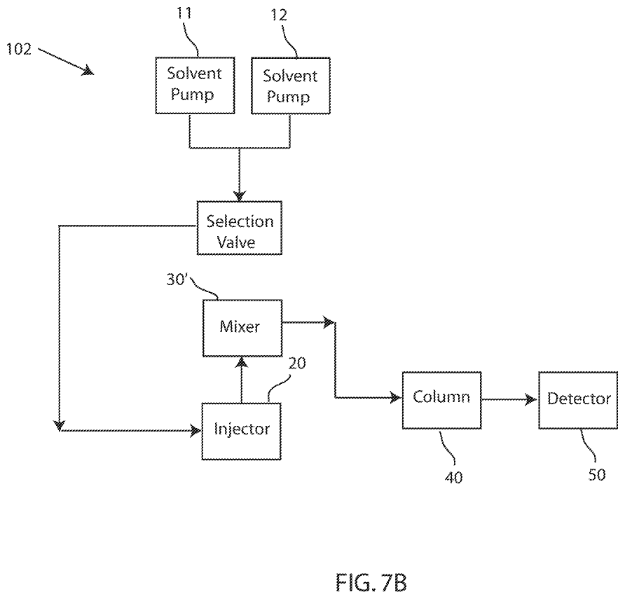

FIGS. 7A-7B depict an alternative embodiment of a liquid chromatography system. The liquid chromatography system shown in FIG. 7A depicts an existing system having two solvent pumps 11, 12 for pumping a strong solvent and a weak solvent, a selection valve, a mixer for mixing the two solvents, an injector 20, a column 40 and a detector 50. In the system shown in FIG. 7A, the mobile phase travels from the pumps 11, 12 to the selection valve to the mixer and to the injector 20 and then to the column 40. The liquid chromatography system 102 shown in FIG. 7B includes a dispersive element 30′, which provides the necessary dispersion to dilute the sample solvent prior to entering the column 40. The liquid chromatography system 102 includes a solvent pump 11 for pumping/delivering a strong solvent and a solvent pump 12 for pumping/delivering a weak solvent. The undiluted mobile phase leaves the injector 20 and is guided back to the existing mixer 30′, which acts a dispersive element as described above (e.g. passive mixing). The diluted mobile phase is then guided directly to the column 40. Accordingly, the liquid chromatography system 102 functions by redirecting the flow paths by selection valve(s) without the need of physically re-plumbing existing liquid chromatography systems.

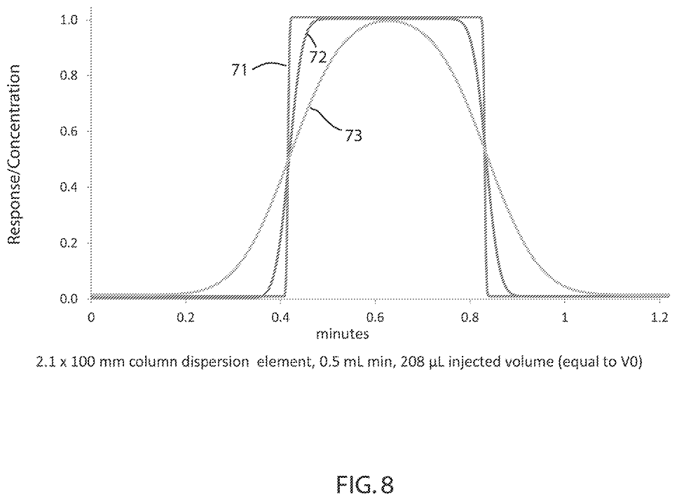

FIG. 8 depicts a first graph showing a dilution of sample solvent with the use of a dispersive element. Line 71 represents a plot of response/concentration over time with the use of a dispersive element 30 packed with 1.7 μm particles. Line 72 represents a plot of response/concentration over time with a pre-column dispersive column having a packed bed of 25 μm particles prior to the mobile phase entering the column. Line 73 represents a plot of response/concentration over time with a pre-column dispersive element having a packed bed of 100 μm particles prior to the mobile phase entering the column. FIG. 8 shows the results of a simulation of an effect of particle size within a dispersive element on an injected peak. A 208 μL volume of sample was injected on a 2.1 mm i.d.×100 mm non-retaining dispersive column element packed with various particle sizes. Line 71 is the sample zone shape after passing through a dispersive element packed with 1.7 μm particles. Because the dispersion of a dispersive element packed with such particles is negligible, the zone is nearly rectangular with a flat top and a maximum response of 1. As a result, no dilution is achieved, and the sample zone continues to the downstream column undiluted and the sample solvent can act as a strong eluent. Line 73 represents a scenario for a dispersive element packed with 100 μm particles, with all other conditions being identical. Substantial dispersion occurs during the sample's passage through the dispersive element, diluting the injected zone into a “Gaussian” peak. However, even with this increased dispersion, its maximum intensity still reaches 1. At this point, the sample solvent is still not adequately diluted, and will impact the chromatographic performance: the injected volume is too large for the dispersive element used.

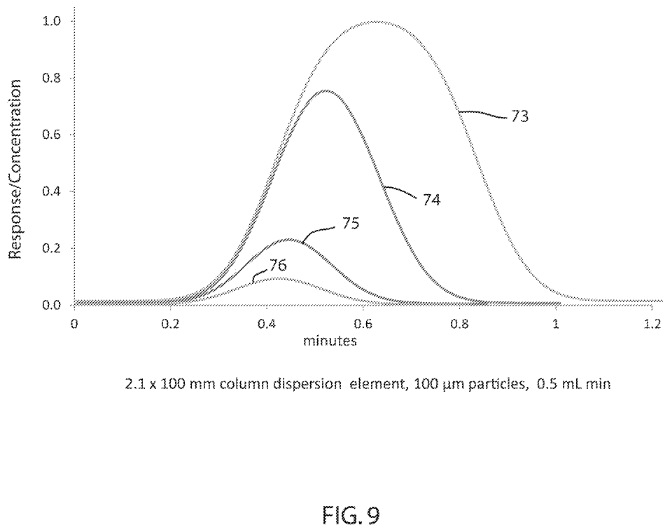

FIG. 9 depicts a second graph showing a dilution of sample solvent with the use of a dispersive element. Line 73 represents a 208 μl injected volume, line 74 represents a 100 μl injected volume, line 75 represents a 25 μl injected volume, and line 76 represents a 10 μl injected volume. The graph of FIG. 9 shows the results of a simulation of the effect of injected sample volume on zone dispersion/dilution. Various volumes were injected on a dispersive element 2.1 mm i.d.×100 mm column, packed with non-retentive 100 μm sorbent). Line 73 represents a 208 μL volume injection, where incomplete dilution is observed (peak top intensity is ˜1). Line 74 represents a 100 μL volume injected to the same dispersive element. Its max intensity is ˜0.76, corresponding to a dilution at the peak apex of 1.3 fold. The dilution factor is significantly greater at the peak front and rear section. Line 75 represents a 25 μL injection, resulting in a 2.3 fold dilution at peak apex. Line 76 represents 10 μL injected volume, resulting in a 9.9 fold dilution at peak apex. A 2-10 fold dilution is a useful range, which can provide the ability to actively focus analytes on the head of the analytical column connected in series. Even though the sample components are diluted along with the sample solvent, the solvent dilution results in greater retention of analytes of interest, resulting in efficient analyte focusing at the head of the column.

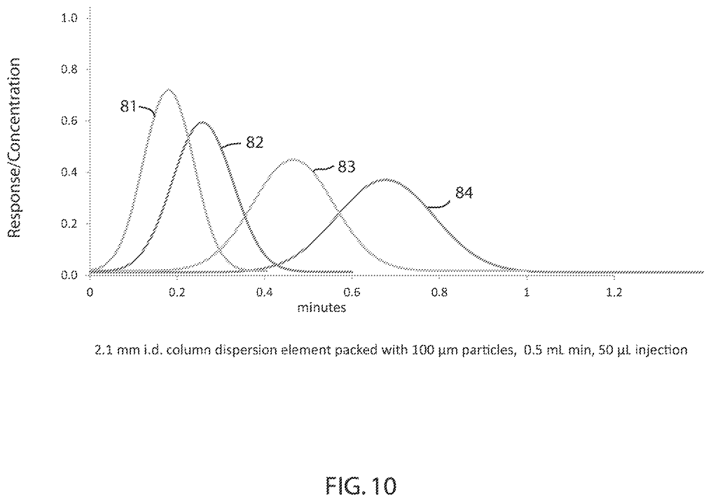

FIG. 10 depicts a third graph showing a dilution of sample solvent with the use of a dispersive element. Line 81 represents a dispersive element column length of 30 mm, line 82 represents a dispersive element column length of 50 mm, line 83 represents a dispersive element column length of 100 mm, and line 84 represents a dispersive element column length of 150 mm. The dispersive element used in this simulation is a 2.1 mm i.d. dispersive element packed with 100 μm particles and an injected volume of 50 μl. FIG. 10 shows a result of a simulation of the effect of the dispersive column element length (30-150 mm) on sample solvent dilution. 50 μL volume was injected on various dispersive elements/columns; shorter dispersive elements provide smaller dispersion and therefore less effectively diluted sample zones.

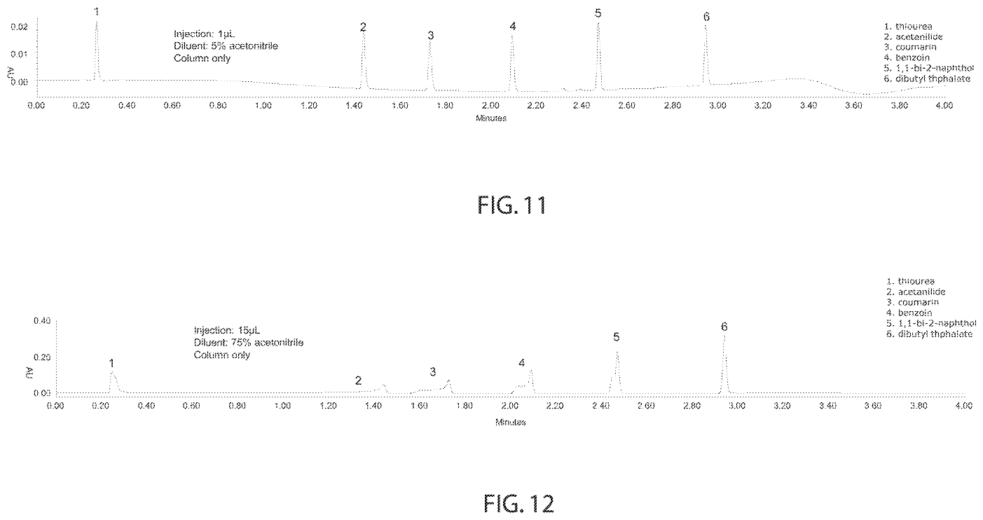

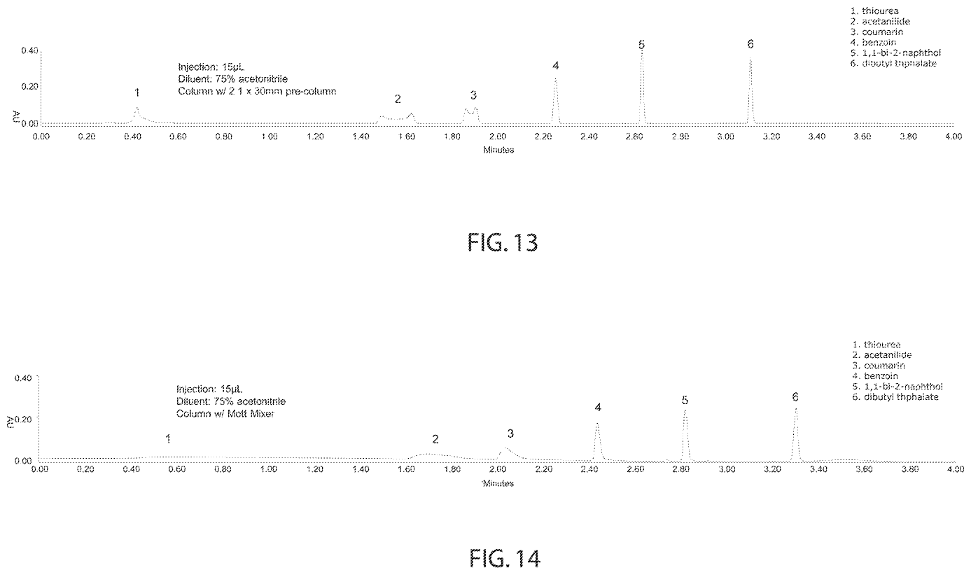

FIGS. 11-17 depict chromatograms showing an impact of using a dispersive element 30. FIG. 11 depicts a chromatogram, wherein a 1 μl sample was injected into the system, with a sample solvent being 5% acetonitrile, without the use of a dispersive element. The peaks 1, 2, 3, 4, 5, and 6 are sharp, due to the low concentration of sample solvent. FIG. 12 depicts a chromatogram, wherein a 15 μl sample was injected into the system, with a sample solvent being 75% acetonitrile, without the use of a dispersive element. The peaks 1, 2, 3, 4, 5, and 6 are distorted, leading to broad, undesirable peaks, due to the undiluted, high concentration of sample solvent. FIG. 13 depicts a chromatogram, wherein a 15 μl sample was injected into the system, with a sample solvent being 75% acetonitrile, with the use of a dispersive element. The dispersive element used for the chromatogram of FIG. 13 is a pre-column 2.1 id×30 mm having a packed bed of substantially non-retentive sorbent materials. Peaks 4, 5, and 6 are sharper, due to the reduction in the concentration of sample solvent by operation of the dispersive element. Peaks 1, 2, and 3 are sharper than without the use of a dispersive element, and can be further improved by increasing the length of the pre-column dispersive element. FIG. 14 depicts a chromatogram, wherein a 15 μl sample was injected into the system, with a sample solvent being 75% acetonitrile, with the use of a dispersive element. The dispersive element used for the chromatogram of FIG. 14 is a frit passive mixer. Peaks 4, 5, and 6 are sharper, due to the reduction in the concentration of sample solvent by operation of the dispersive element.

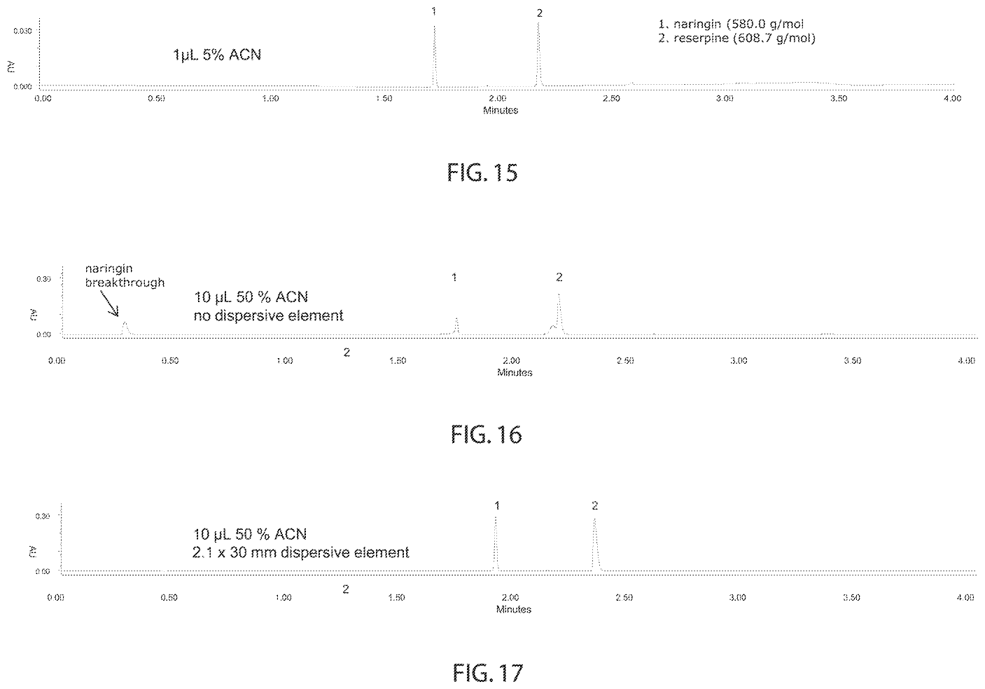

FIG. 15 depicts a chromatogram, wherein a 1 μl sample was injected into the system, with a sample solvent being 5% acetonitrile, without the use of a dispersive element. The peaks 1 and 2 are sharp, due to the low concentration of sample solvent. FIG. 16 depicts a chromatogram, wherein a 10 μl sample was injected into the system, with a sample solvent being 50% acetonitrile, without the use of a dispersive element. The peaks 1 and 2 are distorted, leading to broad, undesirable peaks, due to the undiluted, high concentration of sample solvent. FIG. 17 depicts a chromatogram, wherein a 10 μl sample was injected into the system, with a sample solvent being 50% acetonitrile, with the use of a dispersive element. The dispersive element used for the chromatogram of FIG. 17 is a pre-column 2.1 id×30 mm having a packed bed of substantially non-retentive sorbent materials. Peaks 1 and 2 sharper, due to the reduction in the concentration of sample solvent by operation of the dispersive element.

Referring now to FIGS. 1-17, a method for enabling an injection of a sample dissolved in a strong solvent, in a liquid chromatography may include the steps of disposing a dispersive element between an injector and a column, and diluting a sample solvent of a mobile phase, by the dispersive element, prior to the mobile phase entering the column, wherein, as a function of the diluting, a concentration of the sample solvent in the mobile phase is reduced to mitigate an effect of the strong solvent.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A dispersive element in a liquid chromatography system, the liquid chromatography system including a solvent pump, an injector, a column, and a detector, the dispersive element comprising:
a pre-column body having an inlet end, an outlet end, and dispersing materials disposed therein, wherein the body is positioned between the injector and the column;
wherein the dispersing materials dilute a mobile phase comprising a strong sample solvent prior to entering the column.

2. The dispersive element of claim 1, wherein the dispersing materials are a packed bed of chemically inert, non-retentive sorbent materials

3. The dispersive element of claim 2, wherein the chemically inert, non-retentive sorbent materials have a particle size between 25 μm and 100 μm.

4. The dispersive element of claim 1, wherein the pre-column body is fluidically connected to the injector at the inlet end to receive the mobile phase from the injector.

5. The dispersive element of claim 4, wherein the pre-column body is fluidically connected to the column at the outlet end opposing the inlet end, to deliver the diluted mobile phase to the column.

6. The dispersive element of claim 5, wherein the pre-column body is directly connected to the column at the outlet end.

7. The dispersive element of claim 5, wherein the pre-column body is connected to the column via a length of tubing between the outlet end of the pre-column body and the column.

8. The dispersive element of claim 1, wherein a length and a volume of the pre-column body is less than a length of the column.

9. The dispersive element of claim 8, wherein the length of the pre-column body is between 100 mm and 30 mm.

10. A liquid chromatography system comprising:
a solvent delivery pump for delivering a mobile phase through the liquid chromatography system;
an injector for injecting a sample into the mobile phase;
a column for effecting a separation of components of the sample; and
a dispersive element positioned between the injector and the column, the dispersive element configured to dilute a sample solvent in the mobile phase prior to entering the column.

11. The liquid chromatography system of claim 10, wherein the dispersive element is a length of open tubing having a curvilinear or rectangular cross-section.

12. The liquid chromatography system of claim 10, wherein the dispersive element is a pre-column body having a packed bed of chemically inert, non-retentive sorbent material disposed therein.

13. The liquid chromatography system of claim 10, wherein the dispersive element is a microfluidic mixer.

14. The liquid chromatography system of claim 10, wherein the dispersive element is a frit comprised of chemically inert material.

15. The liquid chromatography system of claim 10, wherein the dispersive element is fluidically connected to:
the injector at an inlet end of the dispersive element to receive the mobile phase from the injector;
the column at an outlet end of the dispersive element opposing the inlet end of the dispersive element, to deliver the diluted mobile phase to the column; or
the column via a length of tubing between the outlet end of the dispersive element and the column.

16. The liquid chromatography system of claim 10, wherein a length and a volume of the dispersive element is less than a length of the column.

17. The liquid chromatography system of claim 10, wherein the dispersive element is one or more dispersive elements in series, prior to the column, the one or more dispersive elements in series configured to progressively dilute the sample solvent in the mobile phase.

18. A liquid chromatography system for controlled dispersion of a mobile phase, the liquid chromatography system comprising:
a solvent delivery pump for delivering the mobile phase through the liquid chromatography system;
an injector for injecting a sample into the mobile phase;
a first flow path fluidically connecting the injector to a dispersive element, wherein a sample solvent is diluted by the dispersive element prior to the mobile phase entering the column; and
a second flow path fluidically connecting the injector to the column to bypass the dispersive element.

19. The liquid chromatography system of claim 18, further comprising one or more flow control devices to control a flow of the mobile phase through the first flow path or the second flow path. wherein the one or more flow control devices is selected from the group consisting of: a jumper, a tool-less connector, a solvent stream selector valve, and a switching valve.

20. The liquid chromatography system of claim 18, wherein the dispersive element is located between the injector and the column.
